(19) United States
(12) Patent Application Publication
(10) Pub. No.: US 2008/0316947 A1
(43) Pub. Date: Dec. 25, 2008

(54) METHOD AND APPARATUS FOR 3G LTE FDD and TDD DETECTION USING REFERENCE SIGNAL CORRELATION

(76) Inventors: Bengt Lindoff, Bjarred (SE); Robert Baldemair, Solna (SE); David Astely, Bromma (SE)

Correspondence Address: ERICSSON INC., 6300 LEGACY DRIVE, M/S EVR 1-C-11, PLANO, TX, 75024, US

(21) Appl. No.: 12/022,649

(22) Filed: Jan. 30, 2008

Related U.S. Application Data
(60) Provisional application No. 60/945,401, filed on Jun. 21, 2007.
(60) Provisional application No. 61/013,792, filed on Dec. 14, 2007.

(51) Int. Cl. H04L 5/14

(52) U.S. Cl. 370/294

(57) ABSTRACT

A method and apparatus for use in a wireless communication system to detect frequency division duplex (FDD) or time division duplex (TDD) after the radio timing and cell group ID have been determined from the S-SyS during a cell search, by correlating reference symbols (RSs) and detecting whether the RSs are on resource elements corresponding to FDD or TDD. By correlating the known RS, which is known after the cell ID is detected, to the assumed RS positions for FDD or TDD, the duplex form is detected.

### CROSS-REFERENCE TO RELATED APPLICATIONS

This application claims the benefit of U.S. Provisional Application Nos. 60/945,401, filed Jun. 21, 2007 and 61/013,792 filed Dec. 14, 2007, the disclosures of which are incorporated herein by reference.

### TECHNICAL FIELD

The present invention relates to communication systems adapted to use Orthogonal Frequency Division Multiplexing (OFDM) modulation techniques. More specifically, the present invention relates to detecting, by an apparatus, whether frequency division duplex (FDD) or time division duplex (TDD) is being used by the communication system.

### BACKGROUND

Evolving mobile cellular standards such as Global System for Mobile Communications (GSM) and Wideband Code Division Multiple Access (WCDMA) will likely require modulation techniques such as OFDM in order to deliver higher data rates. OFDM is a method for multiplexing signals which divides the available bandwidth into a series of frequencies known as sub-carriers.

In order to ensure a smooth migration from existing cellular systems to high capacity, high data rate systems using existing radio spectrum, new systems must be able to operate on a flexible bandwidth (BW). Third generation Long Term Evolution (3G LTE) has been proposed as a new flexible cellular system. 3G LTE is intended as an evolution of the 3G WCDMA standard. 3G LTE will likely use OFDM and operate on BWs spanning from 1.25 MHz to 20 MHz. Data rates of up to 100 Mb/s will be possible in the high BW 3G LTE service.

3G LTE will also be designed for both micro and macro cells, hence two different cyclic prefix (CP) lengths are defined, minimizing the CP overhead for micro cell scenarios (4.7 us) and giving also providing for long a CP in macro cell environment (16.7 us).

Furthermore, in order to ease the migration from legacy systems, 3G LTE is standardized for both frequency division duplex (FDD) and time division duplex (TDD). Although there are many similarities between FDD and TDD, there are some differences in the frame structure. However the same sampling rate, 30.72 MHz, may be used for both frame structures. It is anticipate that data rates of up to 100 Mb/s will be supported for the largest bandwidth of 3G LTE. However, low rate services such as voice are also expected to use 3G LTE. Because 3G LTE is designed for Transmission Control Protocol/Internet Protocol (TCP/IP), voice over IP (VoIP) will likely be the service carrying speech.

An important aspect of 3G LTE is its mobility, hence synchronization symbols and cell search procedures will be important due to the need for the UE to detect and synchronize with cells.

For the 3G LTE FDD mode and TDD mode, the cell search method is performed in the following steps:

1. Five (5) millisecond (ms) timing is identified using the primary synchronization signal (P-SyS). Three different sequences for the P-SyS are defined, and the P-SyS also defines the cell ID within a cell group. There is a one-to-one relationship between the cell ID and the orthogonal reference signal (RS) sequence; hence the orthogonal RS sequence used in the cell is detected. Furthermore, the P-SyS is preferably based on Zadoff-Chu (ZC) codes.

2. Radio timing and cell group ID is found from the secondary synchronization signal (S-SyS). Note that 168 cell groups are assumed. The S-SyS is preferably binary based, and based on interleaving of two short (length 31) codes, that is two S-SyS short codes are put in the sub-carriers alternatively.

3. From steps (1) and (2), the cell ID is detected.

4. The broadcast channel (BCH) is read to receive cell specific system information

The primary synchronization channel (P-SCH) and secondary synchronization channel (S-SyS) are each transmitted twice per 10 ms for both frame structures. FIG. 1 illustrates the location of synchronization channels within a frame 100. As seen therein, for FDD they are transmitted in subframe 0 and 5. In the event the cyclic prefix length is not known, it must be estimated. Typically, this estimation is performed between step 1 and 2 of the above cell search method.

In some cases, an apparatus, such as a mobile terminal or user equipment (UE), is unable to determine whether FDD or TDD is used. This is typically the case when the apparatus is turned on and is performing an initial cell search. In such case, the apparatus must detect whether FDD or TDD is being used.

FIG. 2 illustrates the FDD frame structure, including the P-SyS. FIG. 3 illustrates the frame structure for the TDD case. As can be seen, for TDD the P-SyS is placed in the downlink pilot time slots (DwPTS) and the S-SyS is placed in the last OFDM symbol in subframe 0 and 5. Because the synchronization signals are placed on different positions, they will be at different offsets relative to the reference symbols (RS) (see OFDM symbols labeled R in the FIG. 2 and FIG. 3). FIG. 4 shows which specific resource element (e.g., sub-channel) that is transmitting RSs, showing the first slot (0.5 ms), short CP case, and broadcasts information which, at initial cell search, is not known for the apparatus, be it a mobile terminal or UE.

Therefore, there is a need for an efficient method and apparatus adapted to detect whether FDD or TDD is used. The present invention provides such a method and apparatus.

### BRIEF DESCRIPTION OF THE SEVERAL VIEWS OF THE DRAWINGS

FIG. 1 illustrates the location of synchronization channels within a frame for FDD;

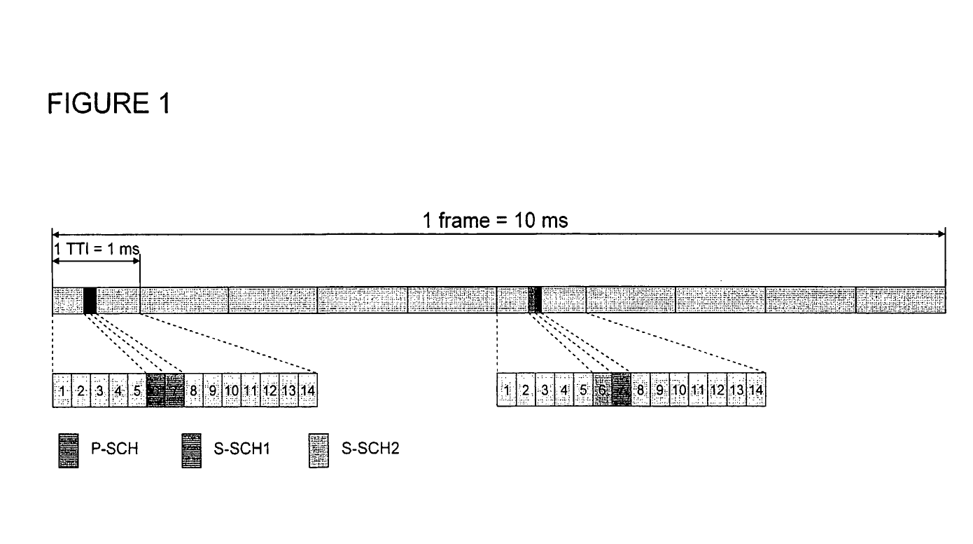

FIG. 2 illustrates the FDD frame structure, including synchronization signals;

FIG. 3 illustrates the TDD frame structure, including synchronization signals;

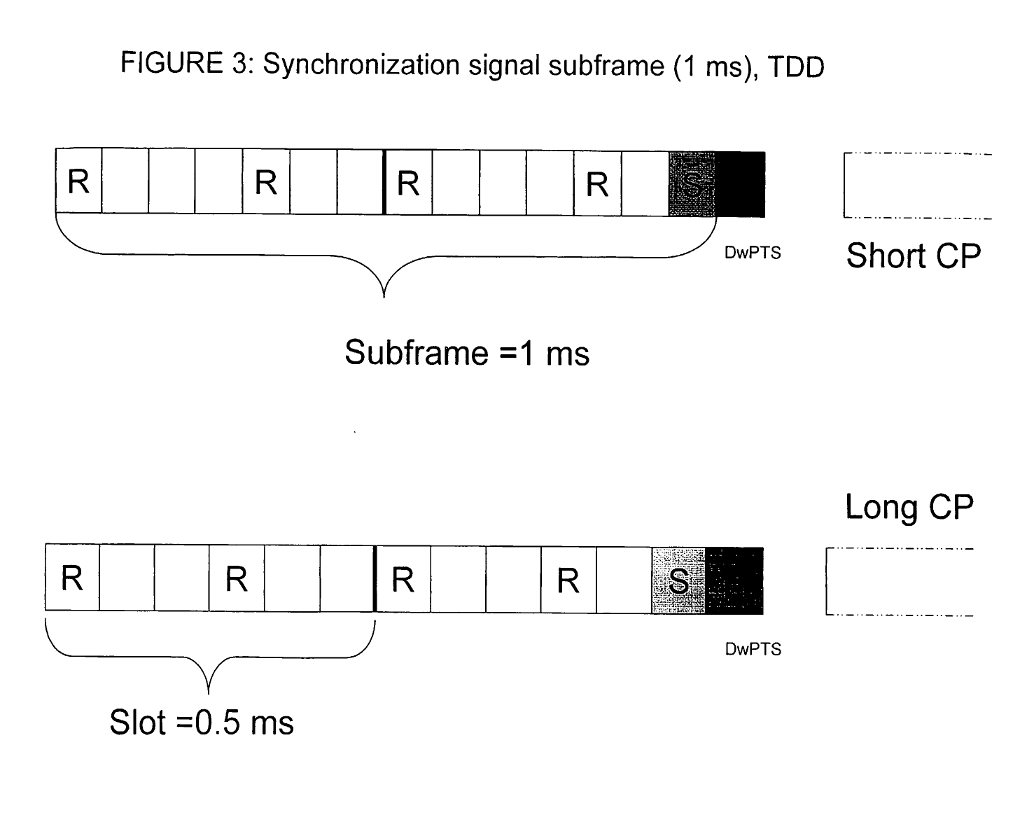

FIG. 4 illustrates which specific resource element that is transmitting reference signals (RSs);

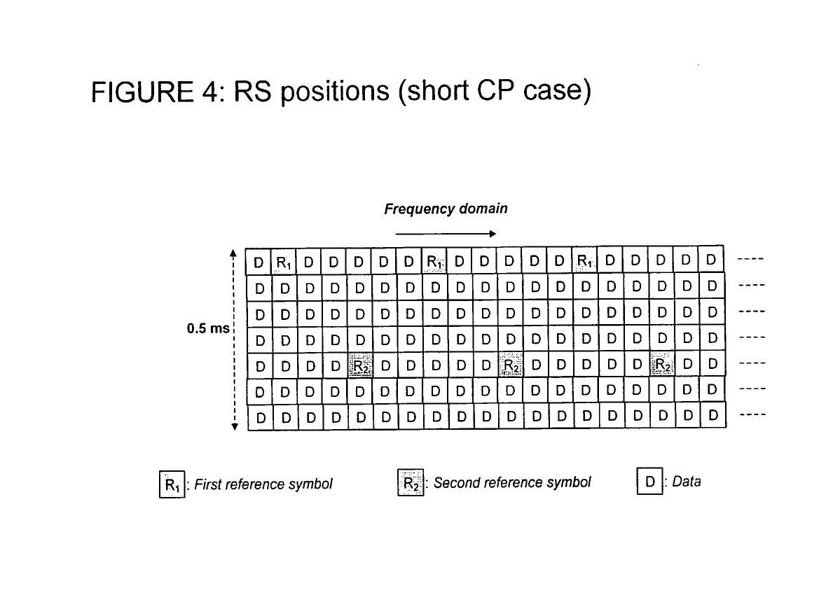

FIG. 5 is a flow chart of a first embodiment of the present invention;

FIG. 6 is a flow chart of a second embodiment of the present invention; and

FIG. 7 is a block diagram of an apparatus of the present invention.

### SUMMARY

The present invention is a method and apparatus that detects FDD or TDD, after the radio timing and cell group ID are determined from the S-SyS, by correlating the reference signals (RSs) and detecting whether the RSs are on resource elements corresponding to FDD or TDD. In such method, and apparatus, radio timing refers to a first or second synchronization sub frame in a 10 ms frame. By correlating the known RS, which is known after the cell ID is detected, to the assumed RS positions for FDD or TDD, the duplex form is detected.

### DETAILED DESCRIPTION

The present invention is a method and apparatus that detects FDD or TDD after finding the radio timing and cell group ID from the S-SyS, by correlating to the RS and detecting whether they are on resource elements corresponding to FDD or TDD, as these have different positions. By correlating the known RS, which is known after the cell ID is detected, to the assumed RS positions for FDD or TDD, the LTE duplex form is detected. In such method, and apparatus, radio timing refers to a first or second synchronization sub frame in a 10 ms frame.

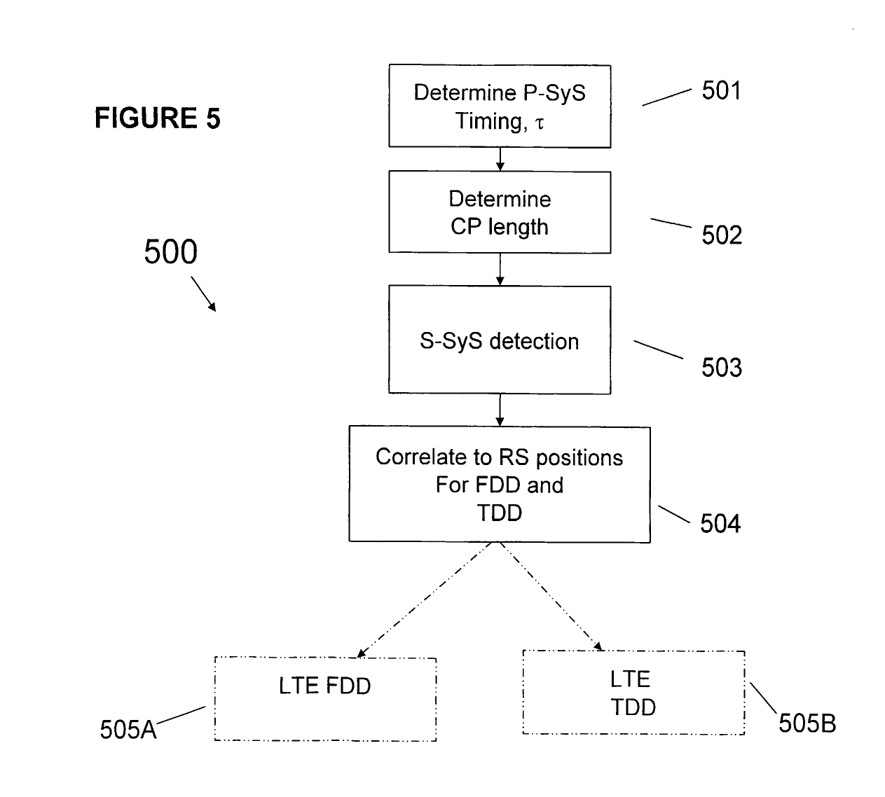

FIG. 5 is a flow chart 500 of a first embodiment of the present invention. As seen therein, in the first step, the five (5) ms timing is determined using the P-SyS 501. In the second step, the CP length is determined 502. The determination of the CP length can be performed in a number of ways and the present invention is not limited in the manner that the CP length is determined. For example, a time domain correlation can be made. In this case, the apparatus, be it a mobile terminal or UE, performs autocorrelation of the received signal with distance Tᵤ corresponding to the OFDM symbol length. The correlation is summed and the power (absolute value) is calculated. Peaks arrive with a distance of Tᵤ+T_{g} where T_{g} is the CP length. From that determination, the CP length can be computed. This time-domain approach is suitable for a single frequency, synchronized, network, such as digital video broadcasting-handheld (DVB-H), where signals from all cells are transmitted with the same CP length and are synchronized. However, this will not be the case with LTE. In LTE, the cells can be sent asynchronously and different cells might have different CP lengths. This, in turn, will result in a risk of multiple correlation peaks making the time domain CP length detection much more complicated. Other methods and related apparatus for determining CP length can also be used. For example, the novel method described in Applicant's co-pending patent application Ser. No. 11/961,603, filed Dec. 20, 2007, can also be used. Once the CP length is determined, the S-SyS is detected in the third step 503. After S-SyS detection, the cell ID is known to the apparatus, as are the scrambling and orthogonal codes for the RS. In the fourth step 504, the resource elements corresponding to RSs for FDD and TDD respectively are correlated. The correlation giving the maximum correlation peak determines whether it is FDD 505A or TDD 505B in addition to the CP. After the FDD or TDD detection, the BCH is read.

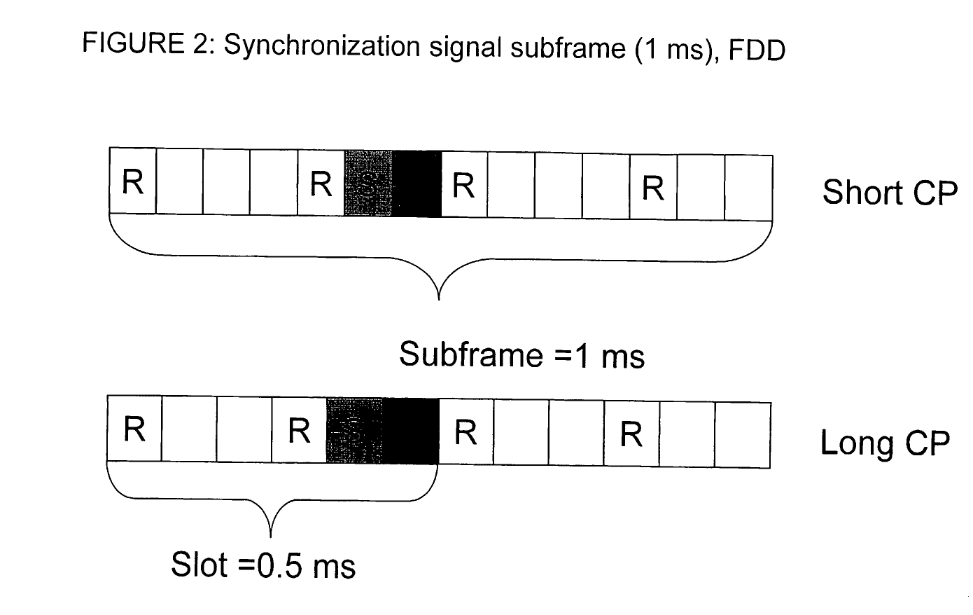

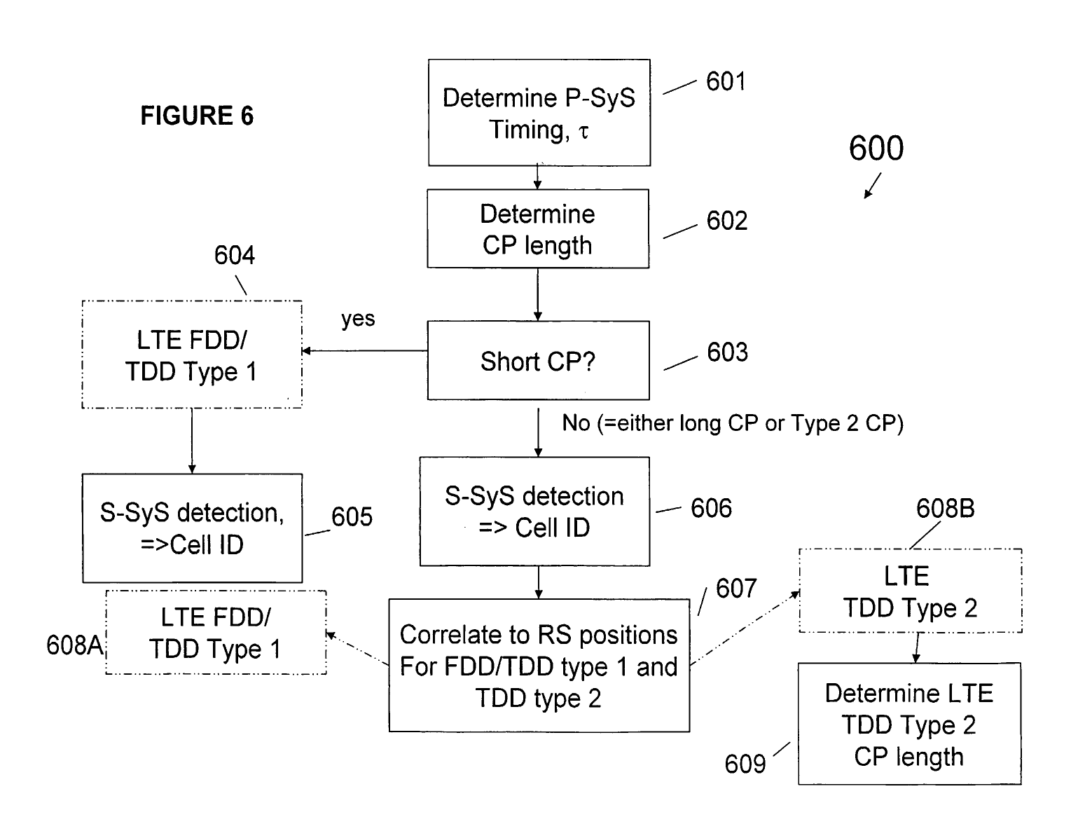

FIG. 6 is a flow chart 600 of a second embodiment of the present invention. This second embodiment of the present invention includes a system with an FDD and two TDD modes, type 1 and 2, wherein the FDD and TDD mode type 1 each have P-SyS and S-SyS at the same positions, and a TDD type 2 mode where the P-SyS is placed in the DwPTS with a CP that is approximately equal to a long CP, regardless of whether a long or short CP is used, and S-SyS is placed in last OFDM symbol. As seen in FIG. 2, in a first step 601, the 5 ms timing is determined using the P-SyS. In step 602, the CP length is determined. As in the first embodiment of the present invention, the determination of the CP length can be performed in a number of ways and the present invention is not limited by the manner that the CP length is determined. If a short CP length is detected in step 603, then it is known that the system is FDD or TDD type 1 in step 604 and, hence, the cell group is detected, in step 605, using the S-SyS. Using the detected P-SyS and S-SyS, the cell ID is determined and the BCH is read. If a long CP is detected in step 603, there could either be 3G LTE FDD/TDD type 1, long CP or 3G LTE TDD type 2 (long or short CP). Further, in such case, the cell group ID detection is made using the S-SyS in step 606, together with P-SyS giving the cell ID. Thereafter, the RS is correlated in step 607, the position and symbols of which, for either type 1/type 2 with normal CP or type 2 with extended CP, are determined by the cell ID information to the potential RS positions for type 1 and type 2. The correlations giving the maximum correlation peak determines whether it is type 1 in step 608A or type 2 in step 608B. In the event it is an LTE TDD Type 2, then the CP length is determined in step 609.

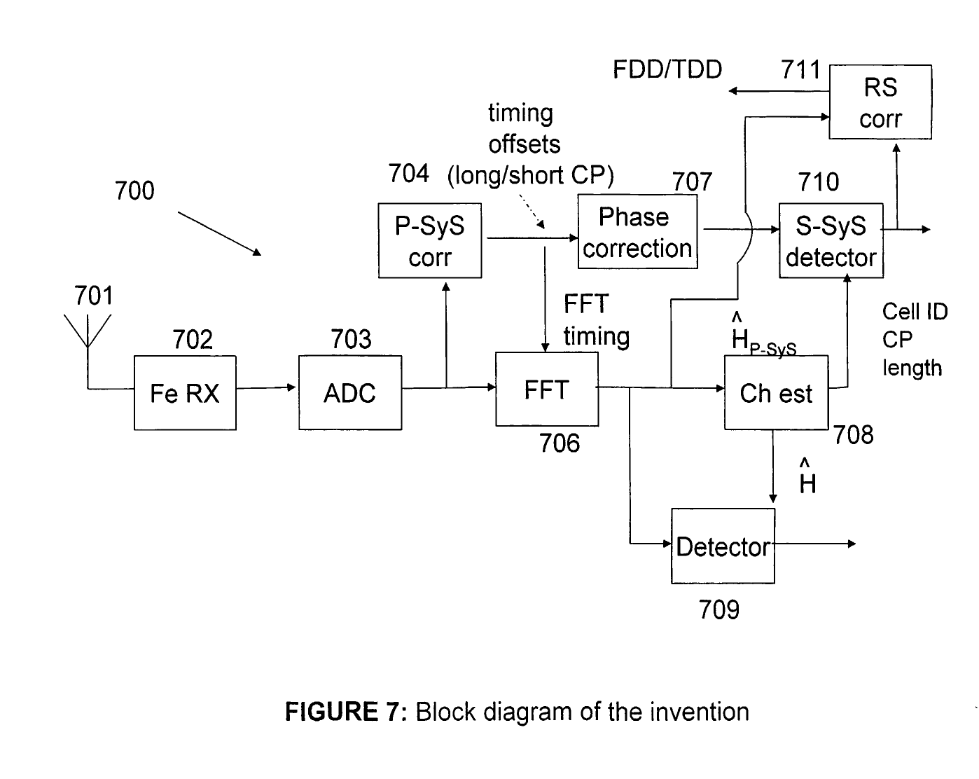

An apparatus adapted to implement the method of the present invention is provided in FIG. 7. FIG. 7 is a block diagram 700 of an apparatus of the present invention, comprising an antenna 701, front end receiver (Fe RX) 702, analog to digital converter (ADC) 703, P-SyS correlation module 704, Fast Fourier Transform module 706, phase correction module 707, channel estimation module 708, detector 709, S-SyS detector 710 and RS correlation unit 711. As seen therein, the apparatus, which may include a UE, is adapted to perform the following operations:

After signal is received at antenna 701 and demodulated at FE RX 702 it is converted into a digital signal at ADC 703. The P-SyS timing is determined using the P-SyS at P-SYS correlation module 704.

An FFT window is placed and the signal is FFT processed to obtain the frequency domain S-SyS symbols at FFT module 706. The frequency domain S-SyS signal is equalized and then phase corrected at phase correction module 707. The cell group ID and CP length are detected by the correlation giving maximum energy in S-SyS detector module 710. In channel estimation unit 708, the channel is estimated. For S-SyS detection, the f-domain representation of the P-SyS is used as pilot signals for the channel estimation used for S-SyS equalization. Furthermore the RSs are used to obtain the channel estimate used for data equalization and detection in detector 709. The apparatus 700 correlates the resource elements corresponding to RSs for FDD and TDD respectively at RS correlation unit 711. The correlation giving the maximum correlation peak which determines whether it is FDD or TDD is performed at RS correlation unit 711.

There have been described and illustrated herein methods and apparatus for detecting, by an apparatus, whether FDD or TDD is being used by the communication system. While particular embodiments of the present invention have been described, it is not intended that the present invention be limited thereto, as it is intended that the invention be as broad in scope as the art will allow and that the specification be read likewise. While the apparatus of the invention is shown in block diagram format, it will be appreciated that the block diagram may be representative of and implemented by hardware, software, firmware, or any combination thereof. Moreover, the functionality of certain aspects of the block diagram can be obtained by equivalent or suitable structure. For example, instead of an FFT, other Fourier transform means could be utilized. It will therefore be appreciated by those skilled in the art that yet other modifications could be made to the provided invention without deviating from its spirit and scope as claimed.

We claim:

1. A method of an Orthogonal Frequency Division Multiplex (OFDM) system, adapted to detect the frequency division duplex (FDD) form or time division duplex (TDD) form comprising the steps of:
detecting the radio timing and cell group ID;
correlating resource elements to the reference symbol (RS); and
detecting whether the RS correspond to FDD or TDD.

2. The method of claim 1, further comprising the step of:
correlating the known RS to the assumed RS positions for FDD or TDD; and
detecting the duplex form.

3. The method of claim 1, for use in a Third Generation Long Term Evolution (3G LTE) compatible system.

4. The method of claim 1, wherein the method is performed as part of a cell search process.

5. The method of claim 1, wherein the radio timing is detected with respect to a first of second synchronization sub frame in a 10 millisecond frame.

6. A method of detecting whether a system is based on frequency division duplex (FDD) or time division duplex (TDD) comprising the steps of:
determining the P-SyS timing using the primary synchronization signal (P-SyS);
detecting the cyclic prefix (CP) length;
determining the radio timing and cell ID using the secondary synchronization signal (S-SyS); and
correlating resource elements corresponding to reference symbols for FDD and TDD respectively.

7. The method of claim 6, wherein the correlating step provides a maximum correlation peak which determines whether it is FDD or TDD, in addition to the CP and after the FDD or TDD detection, the broadcast channel (BCH) is read.

8. The method of claim 6, wherein the CP length is determined using a time domain correlation.

9. A method of detecting whether a system is based on frequency division duplex (FDD) or time division duplex (TDD) comprising the steps of:
determining the P-SyS using the primary synchronization signal (P-SyS);
detecting the cyclic prefix (CP) length;
if a short CP length is detected, then, using the S-SyS and P-SyS, determining the cell ID and reading the broadcast channel (BCH);
if a long CP is detected, detecting the cell group ID using the S-SyS and P-SyS; and
determining type 1 or type 2 by correlating the reference symbols (RSs), and if type 1, reading the broadcast channel (BCH) and if type 2, determining the CP length.

10. An apparatus for use in an Orthogonal Frequency Division Multiplex (OFDM) system, adapted to detect frequency division duplex (FDD) form or time division duplex (TDD) form comprising:
means for finding one of at least two possibilities for the radio timing and cell group ID;
means for correlating resource elements to the reference symbol (RS); and
means for detecting whether the RS are on resource elements corresponding to FDD or TDD.

11. The apparatus of claim 9, further comprising:
means for correlating the known RS to the assumed RS positions for FDD or TDD; and
means for detecting the duplex form.

12. The apparatus of claim 10, for use in a Third Generation Long Term Evolution (3G LTE) compatible system.

13. The apparatus of claim 10, wherein the means for determining the CP length uses a time domain correlation.

14. The apparatus of claim 10, comprising a user equipment (UE).

15. An apparatus, comprising:
an antenna;
a front end receiver (Fe RX) having an input coupled to the antenna;
an analog to digital converter (ADC) having an input coupled to the output of the Fe RX;
a P-SyS correlation module having an input coupled to the output of the ADC;
a Fast Fourier Transform (FFT) module having an input coupled to the output of the ADC and an input coupled to the output of the P-SyS module;
a phase correction module having an input coupled to the output of the P-SyS correlation module;
a channel estimation module having an input coupled to the output of the FFT;
a detector module having an input coupled to the output of the FFT and the output of channel estimation module;
a S-SyS detector having an input coupled to the output of the phase correction module and the output of the channel estimation module; and
an RS correlation unit having an input coupled to the output of the FFT and the S-SyS detector, wherein the RS correlation unit is operable to correlate resource elements to a reference symbol (RS) and detect whether the RS corresponds to FDD or TDD.

16. The apparatus of claim 15, for use in an Orthogonal Frequency Division Multiplexing (OFDM) modulation system.

17. The apparatus of claim 15 for use in a Third Generation Long Term Evolution (3G LTE) system.

18. The apparatus of claim 15, for use in a user equipment (UE).
